(19) United States
(12) Patent Application Publication
(10) Pub. No.: US 2018/0052943 A1
(43) Pub. Date: Feb. 22, 2018

(54) SYSTEMS AND METHODS FOR CONTROLLING WEBPAGE PRE-RENDERING

(71) Applicant: QUALCOMM Incorporated, San Diego, CA (US)

(72) Inventors: Shiu Wai Hui, Richmond Hill (CA); Ahmed Sheikh, Toronto (CA); Veluppillai Arulesan, Toronto (CA)

(21) Appl. No.: 15/240,234

(22) Filed: Aug. 18, 2016

(51) Int. Cl. G06F 17/30

(52) U.S. Cl. CPC G06F 17/30902; G06F 17/3089

(57) ABSTRACT

A method for controlling webpage pre-rendering is described. The method includes receiving at least a portion of a webpage. The method also includes obtaining one or more complexity indicators associated with the webpage. The method further includes estimating an amount of pre-rendering based on the one or more complexity indicators. The method additionally includes pre-rendering an off-screen portion of the webpage according to the amount of pre-rendering.

### FIELD OF DISCLOSURE

The present disclosure relates generally to electronic devices. More specifically, the present disclosure relates to systems and methods for controlling webpage pre-rendering.

### BACKGROUND

Some electronic devices (e.g., computers, laptop computers, cellular phones, smartphones, tablet devices, game consoles, televisions, automobiles, appliances, cameras, set-top boxes, etc.) communicate with other devices. For example, a smartphone may access a local area network (LAN) and/or a wide area network (WAN) (e.g., the Internet). Electronic devices may send data to and/or receive data from one or more devices.

As technology improves, more devices are being used to communicate with other devices. Additionally, many devices are communicating with other devices more often. For example, many people access the Internet for work and recreational purposes many times throughout the day.

Processing data from other devices may be inefficient in some cases. For example, processing unused received data may waste resources (e.g., processing resources, power resources, etc.). As can be observed from this discussion, systems and methods that improve efficiency may be beneficial.

### SUMMARY

A method for controlling webpage pre-rendering is described. The method includes receiving at least a portion of a webpage. The method also includes obtaining one or more complexity indicators associated with the webpage. The method further includes estimating an amount of pre-rendering based on the one or more complexity indicators. The method additionally includes pre-rendering an off-screen portion of the webpage according to the amount of pre-rendering. The method may include storing one or more load complexity indicators based on one or more webpage loads.

The one or more complexity indicators may include a number of layers, a number of frames for webpage load, a size of picture recording, a changing content indicator, and/or a pre-rendering performance. An increased number of layers, an increased number of frames, an increased size of picture recording, a decreased changing content indicator, and/or a decreased pre-rendering performance may contribute to increasing the amount of pre-rendering. A decreased number of layers, a decreased number of frames, a decreased size of picture recording, an increased changing content indicator, and/or an increased pre-rendering performance may contribute to decreasing the amount of pre-rendering.

Obtaining the one or more complexity indicators may include determining one or more current load complexity indicators. Obtaining the one or more complexity indicators may include retrieving one or more stored load complexity indicators.

An electronic device for controlling webpage pre-rendering is also described. The electronic device includes a processor configured to receive at least a portion of a webpage. The processor is also configured to obtain one or more complexity indicators associated with the webpage. The processor is further configured to estimate an amount of pre-rendering based on the one or more complexity indicators. The processor is additionally configured to pre-render an off-screen portion of the webpage according to the amount of pre-rendering.

A computer-program product for controlling webpage pre-rendering is also described. The computer-program product includes a non-transitory tangible computer-readable medium with instructions. The instructions include code for causing an electronic device to receive at least a portion of a webpage. The instructions also include code for causing the electronic device to obtain one or more complexity indicators associated with the webpage. The instructions further include code for causing the electronic device to estimate an amount of pre-rendering based on the one or more complexity indicators. The instructions additionally include code for causing the electronic device to pre-render an off-screen portion of the webpage according to the amount of pre-rendering.

An apparatus for controlling webpage pre-rendering is also described. The apparatus includes means for receiving at least a portion of a webpage. The apparatus also include means for obtaining one or more complexity indicators associated with the webpage. The apparatus further includes means for estimating an amount of pre-rendering based on the one or more complexity indicators. The apparatus additionally includes means for pre-rendering an off-screen portion of the webpage according to the amount of pre-rendering.

### BRIEF DESCRIPTION OF THE DRAWINGS

FIG. 1 is a block diagram illustrating one example of an electronic device in which systems and methods for controlling webpage pre-rendering may be implemented;

FIG. 2 is a flow diagram illustrating one configuration of a method for controlling webpage pre-rendering;

FIG. 3 illustrates an example of a webpage;

FIG. 4 is a flow diagram illustrating a more specific configuration of a method for controlling webpage pre-rendering;

FIG. 5 is a diagram illustrating a timeline of a webpage request and webpage load;

FIG. 6 is a flow diagram illustrating another more specific configuration of a method for controlling webpage pre-rendering;

FIG. 7 is a block diagram illustrating an example of stored load complexity indicator(s) and a pre-rendering controller;

FIG. 8 is a diagram illustrating an example of webpage addresses and complexity indicators that may be stored in accordance with the systems and methods disclosed herein;

FIG. 9 is a diagram illustrating one example of layers of a webpage;

FIG. 10 is a diagram illustrating one example of complex content of a webpage;

FIG. 11 is a diagram illustrating one example of frames for a webpage load;

FIG. 12 is a diagram illustrating one example of pre-rendering performance of a webpage; and

FIG. 13 illustrates certain components that may be included within an electronic device configured to implement various configurations of the systems and methods disclosed herein.

### DETAILED DESCRIPTION

Some configurations of the systems and methods disclosed herein may relate to controlling webpage pre-rendering. In some approaches, the systems and methods disclosed herein may reduce pre-rendering for a browser based on a webpage profile.

When webpages are complex, pre-rendering may be utilized to provide a good user experience. However, performing too much pre-rendering may be inefficient and waste resources, such as processing bandwidth and energy (e.g., battery power).

During webpage loading, a browser may decide how many tiles to render ahead of time in order to reduce the amount of blanking seen by the user. This decision may be dependent on different factors including the complexity of the webpage. For example, if a particular webpage has a lot of content, it may be better to rasterize the content ahead of time, and if the webpage is simple, it may be better to rasterize less to save on power. The systems and methods disclosed herein may provide a mechanism for determining how much to pre-render.

Some configurations of the systems and methods disclosed herein may include profiling and collecting information on a per-page (e.g., website) basis. The information may include one or more measures of webpage complexity such as a number of layers, a number of frames for page load, a size of picture recording (e.g., a number and/or type of draw commands for the webpage), a changing content indicator (e.g., how much the content of the webpage changes, where the changes occur, whether the changes occur in a pre-rendered area, etc.), and pre-rendering performance (e.g., an amount of blanking occurring at one or more previous webpage visits). This information may be collected on the initial load of the page (and refined on subsequent loads). Subsequent loads may utilize the information to control (e.g., adjust) the pre-rendering. For example, if the size of picture recording for any given layer is very large (where “very large” may vary and/or may be tuned), then on the next load the browser may pre-render more tiles for a better user experience. If the recording size is small, then pre-rendering may be reduced to save power.

In some approaches, the number of layers may be collected even on an initial webpage load to estimate pre-rendering for the initial webpage load. Other complexity measures (e.g., number of frames, pre-rendering performance, etc.) may not be known at request time (for an initial webpage load, for example). One or more complexity indicators may be estimated, stored in a webpage profile, and/or updated at some or all webpage loads. The webpage load profile may reflect the complexity of a webpage in terms of the one or more complexity measures. The page load profile may be associated with a webpage address (e.g., Uniform Resource Locator (URL)). For example, each page load profile may be stored in a database that is keyed to a webpage address.

Some configurations of the systems and methods disclosed herein may include one or more of the following features. An electronic device may estimate an amount of pre-rendering for a webpage based on one or more complexity indicators associated with the webpage. The one or more complexity indicators may include a number of layers, a number of frames for webpage load, a size of picture recording, a changing content indicator, and/or a pre-rendering performance. Estimating the amount of pre-rendering may include tending to increase pre-rendering when there is an increased number of layers, an increased number of frames, an increased size of picture recording, a decreased changing content indicator, and/or a decreased pre-rendering performance (e.g., an increased amount of blanking). Estimating the amount of pre-rendering may include tending to decrease pre-rendering when there is a decreased number of layers, a decreased number of frames, a decreased size of picture recording, an increased changing content indicator, and/or an increased pre-rendering performance (e.g., a decreased amount of blanking). The electronic device may store a webpage profile based on one or more webpage loads, where the webpage complexity profile includes one or more complexity indicators.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

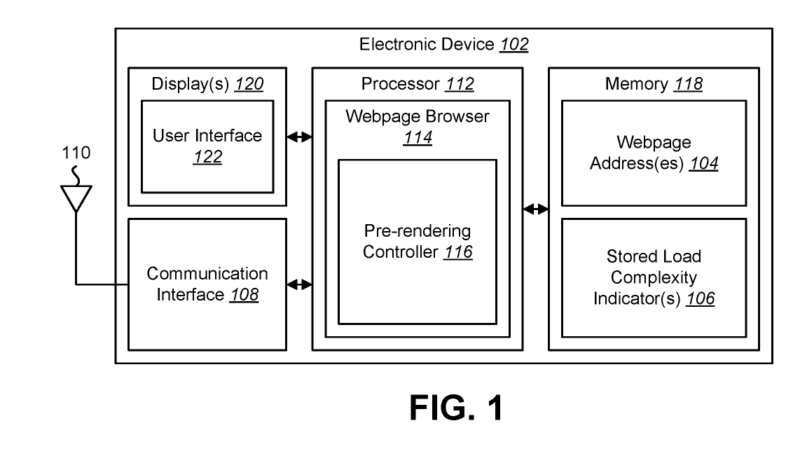

FIG. 1 is a block diagram illustrating one example of an electronic device 102 in which systems and methods for controlling webpage pre-rendering may be implemented. Examples of the electronic device 102 include computers (e.g., desktop computers, laptop computers, etc.), cellular phones, smartphones, tablet devices, media players, televisions, vehicles, cameras, virtual reality devices (e.g., headsets), augmented reality devices (e.g., headsets), mixed reality devices (e.g., headsets), gaming consoles, personal digital assistants (PDAs), set-top boxes, appliances, etc. The electronic device 102 may include one or more components or elements. One or more of the components or elements may be implemented in hardware (e.g., circuitry) or a combination of hardware and software and/or firmware (e.g., a processor with instructions).

In some configurations, the electronic device 102 may include a processor 112, a memory 118, one or more displays 120, and/or a communication interface 108. The processor 112 may be coupled to (e.g., in electronic communication with) the memory 118, display 120, and/or communication interface 108. The processor 112 may be a general-purpose single- or multi-chip microprocessor (e.g., an ARM), a special-purpose microprocessor (e.g., a digital signal processor (DSP), a graphics processing unit (GPU), an image signal processor (ISP), etc.), a microcontroller, a programmable gate array, etc. The processor 112 may be referred to as a central processing unit (CPU). Although just a single processor 112 is shown in the electronic device 102, in an alternative configuration, a combination of processors (e.g., an ISP and an application processor, an ARM and a DSP, a GPU and an application processor, etc.) may be used. The processor 112 may be configured to implement one or more of the methods disclosed herein.

The memory 118 may store instructions for performing operations by the processor 112. The memory 118 may be any electronic component capable of storing electronic information. The memory 118 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

Data and/or instructions may be stored in the memory 118. The instructions may be executable by the processor 112 to implement one or more of the methods described herein. Executing the instructions may involve the use of the data that is stored in the memory 118. When the processor 112 executes the instructions, various portions of the instructions may be loaded onto the processor 112, and various pieces of data may be loaded onto the processor 112.

The processor 112 may access (e.g., read from and/or write to) the memory 118. Examples of instructions and/or data that may be stored by the memory 118 may include one or more webpage addresses 104, one or more stored load complexity indicators 106, webpage browser 114 instructions, and/or pre-rendering controller 116 instructions, etc.

In some configurations, the electronic device 102 may present a user interface 122 on the display 120. For example, the user interface 122 may enable a user to interact with the electronic device 102. For example, the user interface 122 may receive a touch, a mouse click, a gesture and/or some other input indicates a command or request (e.g., a browse command for the webpage browser 114, a search command for the webpage browser 114, a link command for the webpage browser 114, a webpage close command for the webpage browser 114, etc.).

The display(s) 120 may be integrated into the electronic device 102 and/or may be coupled to the electronic device 102. For example, the electronic device 102 may be a smartphone with an integrated display. In another example, the electronic device 102 may be coupled to one or more remote displays 120 and/or to one or more remote devices that include one or more displays 120.

The communication interface 108 may enable the electronic device 102 to communicate with one or more other electronic devices. For example, the communication interface 108 may provide an interface for wired and/or wireless communications. In some configurations, the communication interface 108 may be coupled to one or more antennas 110 for transmitting and/or receiving radio frequency (RF) signals. Additionally or alternatively, the communication interface 108 may enable one or more kinds of wireline (e.g., Universal Serial Bus (USB), Ethernet, etc.) communication. The communication interface 108 may be linked to one or more electronic devices (e.g., routers, modems, switches, servers, etc.). For example, the communication interface 108 may enable network (e.g., personal area network (PAN), local area network (LAN), metropolitan area network (MAN), wide area network (WAN), Internet, and/or public switched telephone network (PSTN), etc.) communications.

In some configurations, multiple communication interfaces 108 may be implemented and/or utilized. For example, one communication interface 108 may be a cellular (e.g., 3G, Long Term Evolution (LTE), CDMA, etc.) communication interface 108, another communication interface 108 may be an Ethernet interface, another communication interface 108 may be a universal serial bus (USB) interface, and yet another communication interface 108 may be a wireless local area network (WLAN) interface (e.g., Institute of Electrical and Electronics Engineers (IEEE) 802.11 interface). In some configurations, the communication interface 108 may send information (e.g., webpage requests, upload data, etc.) to and/or receive information from another device (e.g., another electronic device, a computer, a remote server, etc.). The communication interface 108 may utilize one or more protocols (e.g., transmission control protocol (TCP), Internet protocol (IPv4, IPv6, etc.), hypertext transfer protocol (HTTP), etc.) for communication.

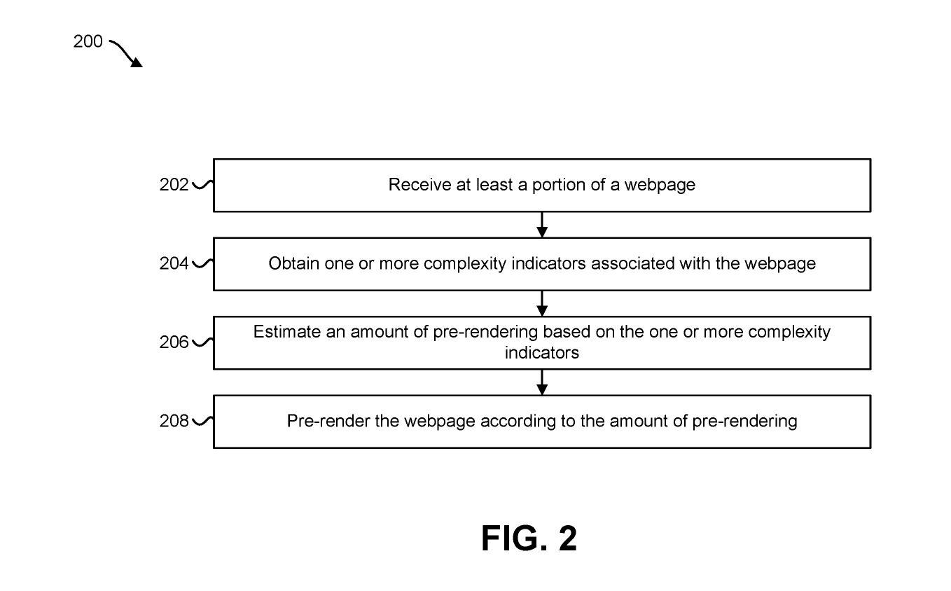

In some configurations, the electronic device 102 may perform one or more of the functions, procedures, methods, steps, etc., described in connection with one or more of FIGS. 2-13. Additionally or alternatively, the electronic device 102 may include one or more of the structures described in connection with one or more of FIGS. 2-13.

The processor 112 may include and/or implement a webpage browser 114. The webpage browser 114 may be an application (e.g., program) that enables accessing one or more webpages. The webpage browser 114 may request and/or receive information (e.g., data) from one or more remote devices (via the communication interface 108, for example). For instance, the webpage browser 114 may request and/or receive one or more webpages (e.g., webpage data, website data, etc.) from one or more remote devices (e.g., web servers, computers, etc.). A webpage may have a corresponding webpage address (e.g., network address, web address, Internet address, uniform resource locator (URL), etc.). One or more webpage addresses 104 may be stored in memory 118. For example, webpage addresses 104 (e.g., URLs) corresponding to previously accessed webpages may be stored in memory 118.

A webpage may include one or more kinds of information. For example, a webpage may include text, one or more images, one or more videos, one or more links (e.g., hyperlinks), and/or one or more objects (e.g., fields, text boxes, buttons, frames, sliders, lists, tables, panels, etc.), etc. A link may include a reference to an address (e.g., network address, web address, Internet address, URL, etc.). For example, webpage content (e.g., text, image(s), video(s), objects, etc.) may be hyperlinked with a link. In some approaches, hyperlinked content may be highlighted and/or may cause a cursor to change on hovering over hyperlinked content to indicate a link.

In some configurations, a webpage may be formatted and/or coded in accordance with one or more languages (e.g., hypertext markup language (HTML), extensible markup language (XML), extensible hypertext markup language (XHTML), JavaScript, cascading style sheets (CSS), etc.). In some approaches, the webpage browser 114 may process (e.g., render) the webpage(s) and/or present the webpage(s) on the display(s) 120.

In some configurations, the electronic device 102 may present a user interface 122 on the display 120. The user interface 122 may enable a user to interact with the electronic device 102. For example, the user interface 122 may receive a touch, a mouse click, a gesture, a keypad input, a keyboard input, and/or some other input that indicates interaction with the electronic device 102.

In some configurations, the webpage browser 114 may produce and/or provide the user interface 122. For example, the user interface 122 may enable a user to interact with a webpage. For instance, the user interface 122 may receive a touch, a mouse click, a gesture, a keypad input, a keyboard input, and/or some other input that indicates interaction with the webpage. A received input may indicate a command for the webpage browser 114 to follow a link on a webpage. For example, the user interface 122 may receive a series of characters (e.g., a web address) from a keyboard, a click or touch (e.g., tap) corresponding to a link (e.g., hyperlinked content) on a webpage, which may indicate a command to browse to the address of a link. The webpage browser 114 may browse to a web address (e.g., request and/or receive information for a webpage at a web address entered into the user interface 122 or a web address of a link on a webpage, etc.). It should be noted that the term “on-screen” may denote at least portion of a webpage that may be presented (e.g., viewable). For example, an on-screen portion of a webpage may be within a viewport of the user interface 122 and/or the webpage browser 114. The term “off-screen” may denote at least portion of a webpage that may not be initially presented (e.g., viewable). For instance, an off-screen portion of a webpage may be outside of a viewport of the user interface 122 and/or the webpage browser 114. For example, an off-screen portion of a webpage may not initially be presented on a display 120, but an off-screen portion of the webpage may be moved on-screen (to be presented on a display 120) and/or a viewport may be moved to view the previously off-screen content.

In some configurations, the webpage browser 114 may include a pre-rendering controller 116. In other configurations, the pre-rendering controller 116 may be separate from the webpage browser 114 (e.g., may be included in and/or implemented by the processor 112 separate from the webpage browser 114). The pre-rendering controller 116 may control pre-rendering. For example, the pre-rendering controller 116 may determine (e.g., estimate) an amount of pre-rendering for one or more webpages.

The electronic device 102 (e.g., processor 112, webpage browser 114, pre-rendering controller 116, etc.) may receive at least a portion of a webpage. For example, the webpage browser 114 may send a webpage request to a remote device (e.g., a remote server) via the communication interface 108. The webpage browser 114 may receive webpage data (via the communication interface 108, for example). For example, the webpage browser 114 may begin receiving a webpage and may begin to load the webpage.

The pre-rendering controller 116 may obtain one or more complexity indicators associated with the webpage. For example, the pre-rendering controller 116 may determine one or more complexity indicators based on a least a portion of a received webpage (e.g., a number of layers, a number of drawing commands, etc.) and/or may retrieve one or more complexity indicators of the one or more stored load complexity indicators 106 in memory 118 (if any).

In some configurations, the one or more stored load complexity indicators 106 may be stored in accordance with one or more webpage profiles. For example, a webpage profile may include a one or more complexity indicators stored from one or more previous loads of a corresponding webpage. In some approaches, the memory 118 may store one or more webpage addresses 104 (e.g., URLs) and/or other webpage indicators (e.g., webpage name, webpage indicator, etc.) in memory 118. The webpage address(es) 104 (or other webpage indicator(s)) may be utilized to structure (e.g., organize) the stored load complexity indicator(s) 106. For example, one or more stored load complexity indicators 106 may be associated with one or more webpage addresses 104 (or other webpage indicators). In some approaches, a webpage profile may include a webpage address 104 and one or more associated stored load complexity indicators 106. In one example, the memory 118 may store a table or array of stored load complexity indicators 106 that is indexed with the webpage addresses 104 (or other webpage indicators). This may allow one or more associated complexity indicators 106 to be obtained (e.g., retrieved) based on a webpage address. For example, when the webpage browser 114 receives a browsing request with a webpage address, the pre-rendering controller 116 may utilize the webpage address to access (e.g., look up) one or more associated stored load complexity indicators 106.

One or more of the complexity indicators may be obtained from a current load (e.g., a current webpage load, one loading has begun). For example, a number of layers may be obtained for a current load. Accordingly, the number of layers may be utilized in estimating an amount of pre-rendering for a current webpage load and/or may be utilized for one or more subsequent webpage loads. Additionally or alternatively, one or more complexity indicators may be obtained from one or more previous loads (e.g., previous webpage loads). For example, a number of layers, a number of frames, a size of picture recording (e.g., number of drawing commands), a changing content indicator, and/or a pre-rendering performance may be obtained from one or more previous loads. Accordingly, a number of layers, a number of frames, a size of picture recording, a changing content indicator, and/or a pre-rendering performance (from a current load) may be utilized for one or more subsequent webpage loads. One or more of the complexity indicators may be stored as one or more stored load complexity indicators 106 in memory 118. This may allow the one or more complexity indicators to be obtained (e.g., retrieved) for determining an amount of pre-rendering for one or more subsequent webpage loads.

A complexity indicator may be a measure and/or a value that indicates an aspect of complexity of a webpage. Some examples of complexity indicators include a number of layers, a number of frames for webpage load, a size of a picture recording, a changing content indicator, and a pre-rendering performance. One or more complexity indicators may be factor(s) in determining an amount of pre-rendering. One or more complexity indicators may be determined based on one or more previous webpage loads and/or a current webpage load. Additionally or alternatively, one or more of the complexity indicators may be determined based on an entire webpage or on one or more portions of a webpage (e.g., an onscreen portion, a viewport portion, one or more off-screen portions, one or more pre-rendering portions, and/or one or more potential pre-rendering portions, etc.).

A number of layers may indicate how many layers and/or a layer depth of a webpage. A webpage may include one or more elements (e.g., images, controls, text, objects, videos, etc.). Each element may have a number of layers. For example, a scrollable text box on a webpage may have two layers: a top layer that provides a view to a bottom scrollable layer that includes text. Other elements that include layers may include animations, elements with transparency effects, composite layers, etc. In some configurations, a number of layers may also include elements that overlap with other elements. For example, a webpage may include a background layer with one or more layers of elements on top of the background layer.

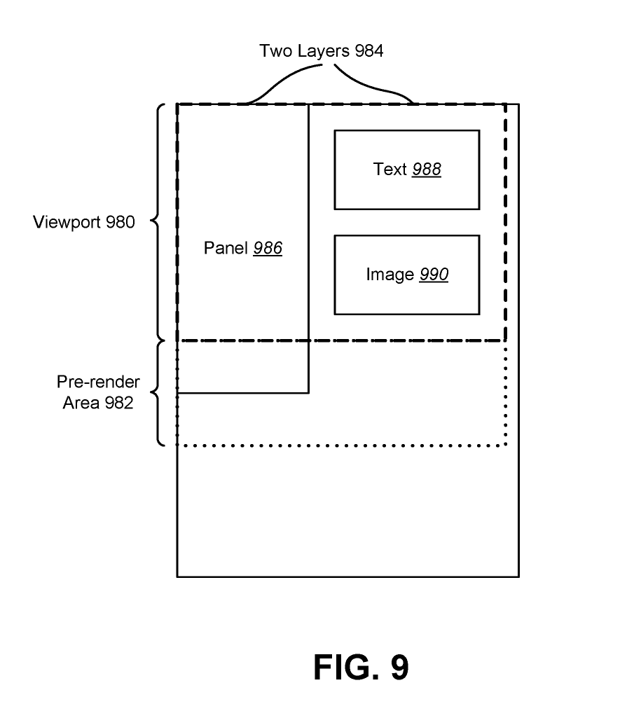

The pre-rendering controller 116 may determine a number of layers based on at least a portion of a webpage. In some approaches, the pre-rendering controller 116 may calculate the number of layers as a maximum number of layers of some elements (e.g., elements within a rendered, on-screen, or viewable portion; elements outside of a viewable portion or viewport, an off-screen portion, or a subset thereof, etc.) or all elements on a webpage. In other approaches, the number of layers may be a total number of layers of some elements (e.g., elements within an area, elements within a rendered or viewable portion, an area outside of a viewport, some elements outside of a viewport, etc.) or all elements on a webpage. For instance, the number of layers may be a total number of layers of elements in an area outside of the viewport that is being evaluated for pre-rendering. In yet another approach, an average number of layers of some elements (e.g., elements within a rendered or viewable portion) or all elements on a webpage may be utilized. An example of layers is given in connection with FIG. 9.

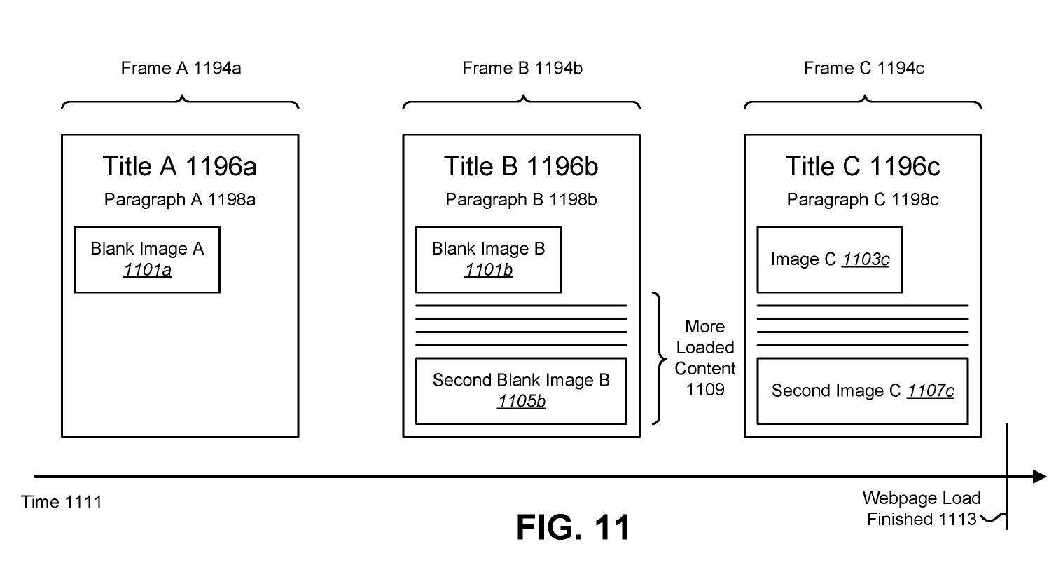

A number of frames for webpage load is another example of a complexity indicator. Each frame of a webpage may be a version of the webpage. For example, each version of the webpage (e.g., each time the webpage changes) due to received data (from a web server, for example) may be a frame of the webpage. In some configurations, the number of frames may not be known before an initial webpage access (e.g., webpage load). The number of frames may be counted for a webpage access (e.g., webpage load). The number of frames may be stored for a subsequent webpage access (e.g., the next time a user visits the webpage, next webpage load, etc.). An example of frames is given in connection with FIG. 11.

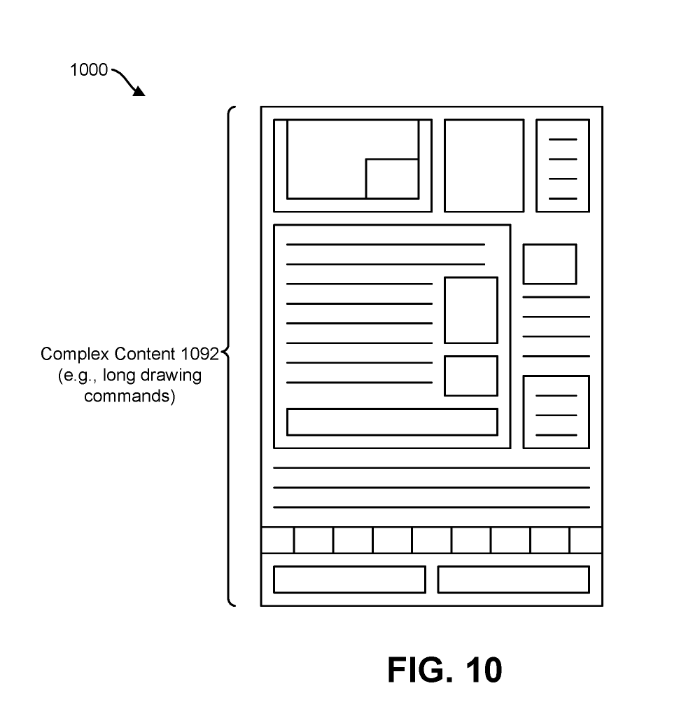

A size of picture recording (or a picture recording size) is another example of a complexity indicator. The size of picture recording may indicate an amount (e.g., number) of drawing commands. In some configurations, the pre-rendering controller 116 may determine the size of picture recording (for a webpage, for instance) by counting a number of drawing commands. For example, the pre-rendering controller 116 may count the number of drawing commands for a webpage while the web browser 114 loads a webpage. The number of drawing commands for the webpage may be the size of picture recording or may be a factor of the size of picture recording. An example of a size of picture recording is given in connection with FIG. 10.

A changing content indicator is another example of a complexity indicator. The changing content indicator may indicate an amount of changing content of a webpage. In some configurations, the pre-rendering controller 116 may determine the changing content indicator (for a webpage, for instance) by determining (e.g., measuring, counting, etc.) a size of one or more dirty areas (e.g., dirty rectangles), a location of one or more dirty areas, a frequency of one or more dirty areas (e.g., dirty rectangles), and/or a number of one or more dirty areas (e.g., dirty rectangles). A dirty area may be an area of the webpage that has changed (for an update, for instance). For example, the pre-rendering controller 116 may determine the dimensions of one or more dirty areas (e.g., dirty rectangles) to determine a size of the changing content. In some approaches, the size of the changing content may be quantified as a proportion of an area (e.g., proportion of the entire webpage, proportion of an off-screen area, etc.). The pre-rendering controller 116 may measure the frequency of changing content by determining how often one or more areas of a webpage change. For example, the frequency of changing content may be determined as an average frequency of changed content for one or more areas (e.g., rectangles) of the webpage. The changing content indicator may be based on the size of one or more dirty areas, the location of the one or more dirty areas, the frequency of changing content, or any combination thereof. For example, the changing content indicator may be a measure that includes the size of the dirty area(s), the location of the dirty area(s), and/or the frequency of changing content as factors. The changing content indicator may be determined (e.g., measured) during webpage load. A graphics interchange format (gif) image is one example of an area of a webpage that may change frequently.

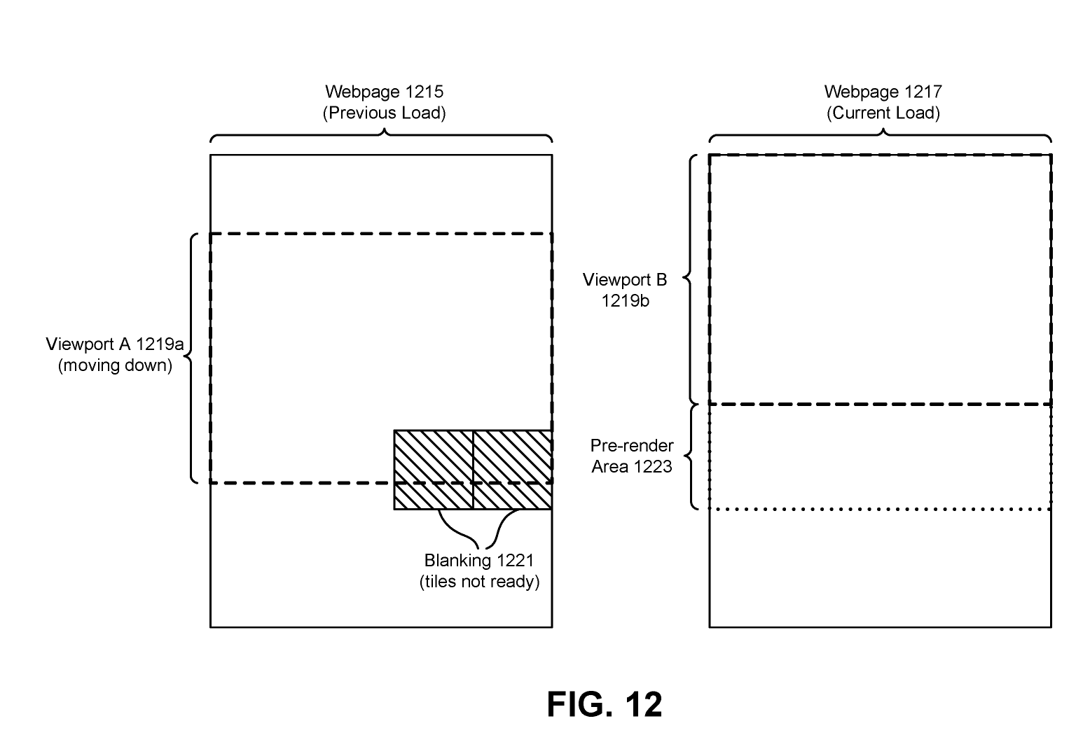

A pre-rendering performance is another example of a complexity indicator. The pre-rendering performance may indicate an amount of time spent pre-rendering and/or a degree to which pre-rendering has supplied webpage content. For example, blanking may occur if pre-rendering did not supply enough webpage content. Blanking occurs when some previously off-screen content is moved on-screen (e.g., when the webpage browser 114 scrolls to a previously off-screen portion of the webpage) but appears blank because the content has not been rendered. In some configurations, the pre-rendering controller 116 may determine the pre-rendering performance by counting an amount of blanking that has occurred for a webpage load. For example, the pre-rendering controller 116 may determine a size of a blanked area, a number of blank elements, a number of frames with blanking content, a number of pixels in a blank area relative to a number of pixels on-screen, and/or the average duration of blanking, etc. The size of a blanked area (and/or a number of blank elements, for instance) may be the pre-rendering performance or may be a factor of the pre-rendering performance. An example of pre-rendering performance (e.g., blanking) is given in connection with FIG. 12.

It should be noted that pre-rendering performance may take user behavior into account (e.g., may be impacted by user behavior). For example, if a user tends to scroll webpages quickly and/or frequently, blanking may occur more often. Accordingly, the pre-rendering performance may indicate poor performance when an increased amount of blanking is occurring. Poor pre-rendering performance may contribute to an increased amount of pre-rendering, which may address (e.g., partially address) user behavior to provide an improved user experience with less blanking.

The pre-rendering controller 116 may estimate an amount of pre-rendering based on the one or more complexity indicators. For example, the pre-rendering controller 116 may determine an amount of pre-rendering using one or more complexity indicators. Each of the one or more complexity indicators may indicate (e.g., may include a range of values indicating) whether more or less pre-rendering may be beneficial (e.g., may improve performance and/or efficiency).

For example, an increased number of layers may imply that an increased amount of pre-rendering may be beneficial, while a decreased number of layers may imply that a decreased amount of pre-rendering may be beneficial. In particular, a larger number of layers may utilize more rendering resources. Accordingly, increasing pre-rendering may allow enough off-screen content to be pre-rendered, which may avoid blanking. Fewer resources may be utilized to render a smaller number of layers. Accordingly, decreasing pre-rendering may conserve resources (e.g., power, processing, etc.) for a webpage with fewer layers (while avoiding blanking, for instance). It should be noted that an “increased” number of layers and/or a “decreased” number of layers may be relative to a threshold number of layers or an operating point number of layers. The threshold number of layers or operating point number of layers may be predetermined, tunable, and/or adaptive.

Additionally or alternatively, an increased number of frames may imply that an increased amount of pre-rendering may be beneficial, while a decreased number of frames may imply that a decreased amount of pre-rendering may be beneficial. In particular, a larger number of frames may utilize more rendering resources. Accordingly, increasing pre-rendering may allow enough off-screen content to be pre-rendered, which may avoid blanking. Fewer resources may be utilized to render a smaller number of frames. Accordingly, decreasing pre-rendering may conserve resources (e.g., power, processing, etc.) for a webpage with fewer frames (while avoiding blanking, for instance). It should be noted that an “increased” number of frames and/or a “decreased” number of frames may be relative to a threshold number of frames or an operating point number of frames. The threshold number of frames or operating point number of frames may be predetermined, tunable, and/or adaptive.

Additionally or alternatively, a decreased changing content indicator may imply that an increased amount of pre-rendering may be beneficial, while an increased changing content indicator may imply that a decreased amount of pre-rendering may be beneficial. In particular, changing content may need to be re-rendered upon changing. Accordingly, pre-rendering off-screen content that changes frequently and/or changes a large amount of content may waste resources, since the changing content may need to be re-rendered when the content is on-screen. Thus, increasing pre-rendering for a decreased changing content indicator may allow enough unchanging off-screen content to be pre-rendered, which may avoid blanking. Decreasing pre-rendering may conserve resources (e.g., power, processing, etc.) for a webpage with frequent and/or sizeable changing content. It should be noted that an “increased” changing content indicator and/or a “decreased” changing content indicator may be relative to a threshold changing content indicator or an operating point changing content indicator. The threshold changing content indicator or operating point changing content indicator may be predetermined, tunable, and/or adaptive.

Additionally or alternatively, a decreased pre-rendering performance may imply that an increased amount of pre-rendering may be beneficial, while an increased pre-rendering performance may imply that a decreased amount of pre-rendering may be beneficial. In particular, a large amount of blanking may lead to a poor user experience. Accordingly, increasing pre-rendering for a webpage where a previous amount of pre-rendering has resulted in more blanking may allow enough off-screen content to be pre-rendered, which may reduce and/or avoid blanking. Decreasing pre-rendering may conserve resources (e.g., power, processing, etc.) for a webpage with acceptable or good pre-rendering performance (e.g., with little or no blanking). It should be noted that an “increased” pre-rendering performance and/or a “decreased” pre-rendering performance may be relative to a threshold pre-rendering performance or an operating point pre-rendering performance. The threshold pre-rendering performance or operating point pre-rendering performance may be predetermined, tunable, and/or adaptive.

In some configurations, the pre-rendering controller 116 may estimate the amount of pre-rendering with a function using one or more complexity indicators. For example, the function may utilize one or more of the complexity indicators as one or more inputs and may output an amount of pre-rendering. In some approaches, estimating the amount of pre-rendering may be accomplished in accordance with Equation (1).

Prerender=aL+bD+cF+dB (1)

In Equation (1), Prerender is an amount of pre-rendering, L is a number of layers, D is a number of drawing commands (which may be one example of size of picture recording), F is a number of frames for page load, and B is an amount of blanking (which may be one example of pre-rendering performance). The parameters a, b, c, and d are tunable parameters (e.g., scaling factors, weights, etc.). Equation (1) may be an example of a scoring approach. It should be noted that other factors (e.g., changing content indicator) may be utilized in a scoring approach. As illustrated in Equation (1), larger (e.g., increased) combinations of complexity indicators (e.g., weighted complexity indicators) may result in larger (e.g., increased) amounts of pre-rendering. Smaller (e.g., decreased) combinations of complexity indicators (e.g., weighted complexity indicators) may result in smaller (e.g., decreased) amounts of pre-rendering.

In additional or alternative approaches, each of the one or more complexity indicators may have an associated threshold or operating point. The amount of pre-rendering may be estimated based on whether the one or more complexity indicators are at, above (e.g., “increased”), or below (e.g., “decreased”) associated threshold(s) and/or operating point(s). In some approaches, the amount of pre-rendering may be additionally based on a degree to which each complexity indicator is above or below associated threshold(s) and/or operating point(s). For example, if a complexity indicator is 10% above an associated threshold, the pre-rendering amount may be increased by 10%, whereas if a complexity indicator is 30% above an associated threshold, the pre-rendering amount may be increased by 30%.

In some approaches, estimating the amount of pre-rendering may be based on a multidimensional space, where each dimension corresponds to one of the complexity indicators. For example, the multidimensional space may include a multidimensional threshold or operating point (e.g., boundary). The multidimensional threshold or operating point may divide a first space for increasing pre-rendering from a second space for decreasing pre-rendering. For example, if a set of complexity indicators (e.g., a complexity indicator vector) is in the first space, the pre-rendering controller 116 may increase an amount of pre-rendering. If a set of complexity indicators (e.g., a complexity indicator vector) is in the second space, the pre-rendering controller 116 may decrease an amount of pre-rendering. If a set of complexity indicators (e.g., a complexity indicator vector) is on the multidimensional threshold or operating point, the pre-rendering controller 116 may maintain an amount of pre-rendering. Increasing, decreasing, or maintaining the amount of pre-rendering may be relative to an amount of pre-rendering performed for a previous webpage load or a default amount of pre-rendering. In some configurations, the amount of pre-rendering may vary based on a degree that the set of complexity indicators (e.g., a complexity indicator vector) is in the first space or the second space. For example, the pre-rendering controller 116 may determine a distance (e.g., closest distance) between the complexity indicator vector and the multidimensional threshold or operating point. Larger adjustments (e.g., increases or decreases depending on the space in which the complexity indicator vector resides) in the amount of pre-rendering may be performed for larger distances.

The webpage browser 114 may pre-render one or more webpages according to an amount of pre-rendering. For example, the pre-rendering controller 116 may produce the estimated amount of pre-rendering, which the webpage browser 114 may utilize to pre-render a webpage (e.g., a portion of the webpage) when the webpage is loaded. For instance, the webpage browser 114 may pre-render an amount of a webpage that is initially off-screen according to the estimated amount of pre-rendering for the webpage. In some configurations, pre-rendering may include determining a set of pixels (e.g., rasterizing) webpage content. For example, the webpage browser 114 may instruct the processor 112 and/or another component (e.g., a graphics processing unit (GPU), etc.) to render a portion (e.g., an off-screen portion) of the webpage according to the estimated amount of pre-rendering.

It should be noted that one or more of the elements or components of the electronic device 102 may be combined and/or divided. For example, the webpage browser 114 and/or the pre-rendering controller 116 may be combined. Additionally or alternatively, one or more of the webpage browser 114 and/or the pre-rendering controller 116 may be divided into elements or components that perform a subset of the operations thereof.

FIG. 2 is a flow diagram illustrating one configuration of a method 200 for controlling webpage pre-rendering. The method 200 may be performed by one or more of the electronic devices described herein (e.g., the electronic device 102 described in connection with FIG. 1). The electronic device 102 may receive 202 at least a portion of a webpage. This may be accomplished as described in connection with FIG. 1. For example, the electronic device 102 may receive webpage data for all or a portion of a webpage. The at least a portion of the webpage may be received 202 in response to a request for a webpage sent by the electronic device 102.

The electronic device 102 may obtain 204 one or more complexity indicators associated with the webpage. This may be accomplished as described in connection with FIG. 1. For example, the electronic device 102 may determine one or more complexity indicators based on the at least a portion of the webpage received 202 (e.g., the current load) and/or may retrieve one or more complexity indicators stored in memory (e.g., one or more stored load complexity indicators).

The electronic device 102 may estimate 206 an amount of pre-rendering based on the one or more complexity indicators. This may be accomplished as described in connection with FIG. 1. For example, the electronic device 102 may increase, decrease, or maintain an amount of pre-rendering based on the one or more complexity indicators. For instance, the electronic device 102 may estimate a higher amount of pre-rendering if one or more complexity indicators and/or a combination thereof weigh towards more pre-rendering or may estimate a lower amount of pre-rendering if one or more complexity indicators and/or a combination thereof weigh towards less pre-rendering.

The electronic device 102 may pre-render 208 the webpage (e.g., an off-screen portion of the webpage) according to the amount of pre-rendering. This may be accomplished as described in connection with FIG. 1. For example, the electronic device 102 may pre-render 208 an amount of the webpage (e.g., an off-screen portion) as indicated by the amount of pre-rendering estimated 206. In some configurations, the webpage may be presented on a display.

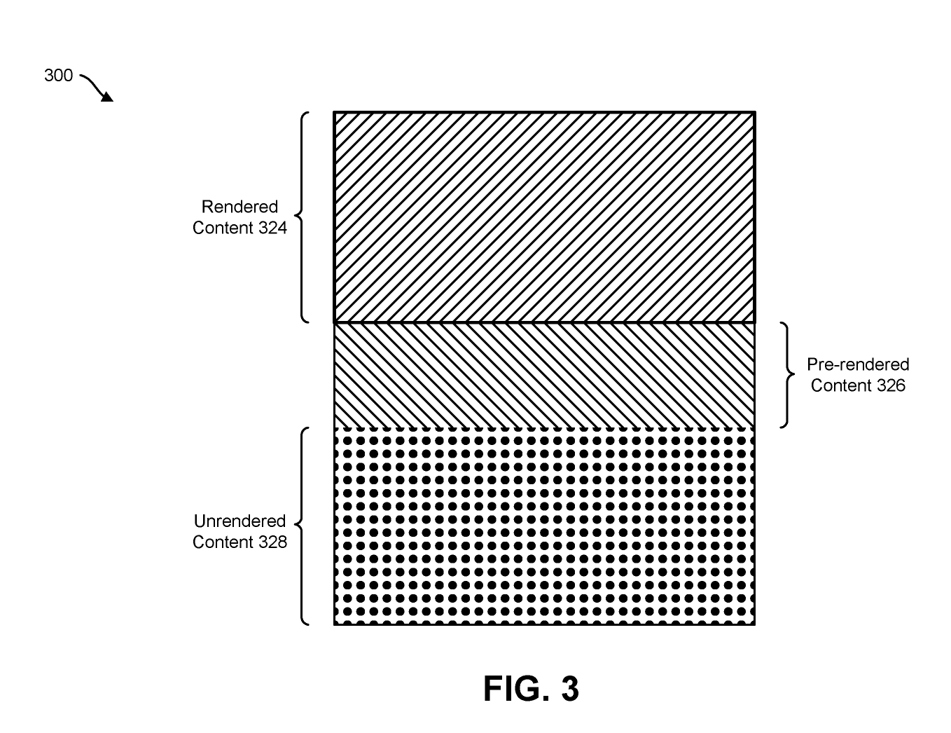

FIG. 3 illustrates an example of a webpage 300. In particular, FIG. 3 illustrates rendered content 324 of the webpage 300, pre-rendered content 326 of the webpage 300 and unrendered content 328 of the webpage 300. As the webpage 300 is received and initially loaded, the electronic device 102 may produce rendered content 324 of an on-screen (e.g., viewport, viewable, etc.) portion of the webpage 300. For example, the rendered content 324 may be in a viewport of a webpage browser 114 when the webpage 300 is loaded.

The webpage 300 may also include pre-rendered content 326 when the webpage is initially loaded. The pre-rendered content 326 may be a portion of the webpage 300 that is rendered for presentation. For example, the electronic device 102 may pre-render a portion of the webpage 300 in anticipation that the pre-rendered content 326 may be moved on-screen (e.g., that the content may be moved into the viewable area of the webpage browser 114, that the viewport may be moved to the pre-rendered content 326, etc.). For instance, the webpage browser 114 may scroll (in response to a received user input, for example) the webpage 300 down to the pre-rendered content 326. In other words, the pre-rendered content 326 may be proactively rendered content that is off the screen (initially). The pre-rendered content 326 area may be quantified as a proportion of screen size. For example, pre-rendering a percentage of a screen full of data may be a percentage of the pixels of that screen.

The unrendered content 328 may be content that has not been rendered. For example, the electronic device 102 may leave a portion of the webpage 300 unrendered in order to conserve resources (e.g., power, processing, etc.).

In a case that the amount of pre-rendered content 326 is too small (e.g., if webpage browser 114 scrolls past the pre-rendered content 326), the webpage browser 114 may present blanking (e.g., blank content, one or more blank tiles, etc.) while the electronic device 102 renders the unrendered content 328 for presentation.

The systems and methods disclosed herein may determine the amount of pre-rendered content 326 with an objective to have enough pre-rendered content 326 to avoid blanking while conserving resources. For example, the systems and methods disclosed herein may attempt to avoid unnecessarily rendering content that is unlikely to be viewed and/or that will have changed by the time it is presented. The amount of pre-rendered content 326 may be based on webpage complexity. As described in connection with one or more of FIGS. 1-2, one or more complexity indicators may be utilized to determine an amount of pre-rendered content 326 to provide good pre-rendering performance while conserving resources.

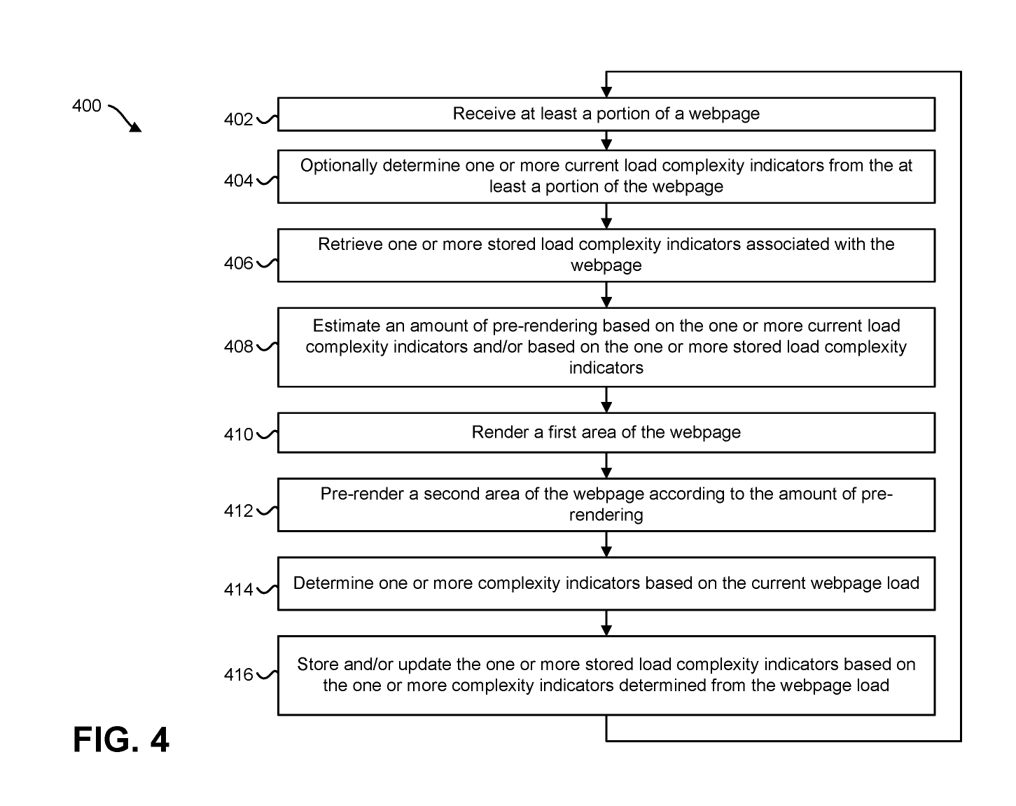

FIG. 4 is a flow diagram illustrating a more specific configuration of a method 400 for controlling webpage pre-rendering. The method 400 may be performed by one or more of the electronic devices described herein (e.g., the electronic device 102 described in connection with FIG. 1). The electronic device 102 may receive 402 at least a portion of a webpage. This may be accomplished as described in connection with one or more of FIGS. 1-3.

The electronic device 102 may optionally determine 404 one or more current load complexity indicators from the at least a portion of the webpage. This may be accomplished as described in connection with one or more of FIGS. 1-2. For example, the electronic device 102 may utilize received webpage data (for a current load, for instance) to determine one or more complexity indicators (e.g., a number of layers, a number of drawing commands, etc.).

The electronic device 102 may retrieve 406 one or more complexity indicators associated with the webpage (if any). This may be accomplished as described in connection with one or more of FIGS. 1-2. For example, the electronic device 102 may retrieve one or more complexity indicators stored in memory (e.g., one or more stored load complexity indicators). The one or more stored load complexity indicators in memory may be complexity indicator(s) determined based on one or more previous webpage loads. In some configurations, the electronic device 102 may utilize the webpage address to retrieve the one or more complexity indicators.

The electronic device 102 may estimate 408 an amount of pre-rendering based on the one or more current load complexity indicators and/or based on the one or more stored load complexity indicators. This may be accomplished as described in connection with one or more of FIGS. 1-3. For example, the electronic device 102 may increase, decrease, or maintain an amount of pre-rendering based on the one or more current load complexity indicators and/or stored load complexity indicators. For instance, the electronic device 102 may estimate a higher amount of pre-rendering if one or more complexity indicators and/or a combination thereof weigh towards more pre-rendering or may estimate a lower amount of pre-rendering if one or more complexity indicators and/or a combination thereof weigh towards less pre-rendering.

The electronic device 102 may render 410 a first area of the webpage. This may be accomplished as described in connection with one or more of FIGS. 1 and 3. For example, the electronic device 102 may render 410 an area of the webpage (e.g., an area of the webpage in a viewport, an on-screen area, etc.). In some configurations, the webpage browser 114 may instruct the processor 112 and/or another component (e.g., a GPU, graphics chip, etc.) regarding the first area to render. Rendering may include producing a set of pixels for (e.g., rasterizing) the webpage content in the first area.

The electronic device 102 may pre-render 412 a second area of the webpage (e.g., an off-screen portion of the webpage) according to the amount of pre-rendering. This may be accomplished as described in connection with one or more of FIGS. 1-3. For example, the electronic device 102 may pre-render 412 an amount of the webpage (e.g., an off-screen portion) as indicated by the amount of pre-rendering estimated 408. Pre-rendering 412 may include producing a set of pixels for (e.g., rasterizing) the webpage content in the second area. The amount of pre-rendering may be quantified as one or more dimensional ranges (e.g., width and/or height dimensions, webpage location(s), etc.), as a set of elements (e.g., one or more images, controls, videos, text, etc.), etc.

The electronic device 102 may determine 414 one or more complexity indicators based on the current webpage load. This may be accomplished as described in connection with FIG. 1. For example, the electronic device 102 may determine one or more complexity indicators based on measurements associated with the current webpage load. For instance, the electronic device 102 (e.g., pre-rendering controller 116) may measure and/or calculate a number of layers, a number of frames for webpage load, a size of picture recording, a changing content indicator, and/or a pre-rendering performance.

The electronic device 102 may store and/or update 416 the one or more stored load complexity indicators based on the one or more complexity indicators determined from the webpage load. This may be accomplished as described in connection with FIG. 1. For example, the electronic device 102 may store the one or more complexity indicators (e.g., number of layers, size of picture recording, number of frames for webpage load, pre-rendering performance, etc.) in memory. The one or more complexity indicators may be associated with a webpage address or other webpage indicator in some configurations. In the case of an initial webpage load, a new record (e.g., webpage profile) may be created for the webpage. In the case of a subsequent webpage load, an existing record (e.g., webpage profile) may be updated. Updating may include overwriting one or more complexity indicators in memory. Additionally or alternatively, updating may include combining one or more stored load complexity indicators with one or more complexity indicators from the current webpage load. For example, the electronic device 102 may calculate an average complexity indicator with a current complexity indicator and a stored load complexity indicator. In some configurations, the average may be weighted (based on the number of webpage loads). For example, if the webpage has been previously loaded 3 times before the current load, the complexity indicator from the current load may be given a 0.25 weight and the stored load complexity indicator may be given a 0.75 weight. Updating the stored load complexity indicator(s) may allow the complexity indicator(s) from the current load to be used for one or more subsequent loads.

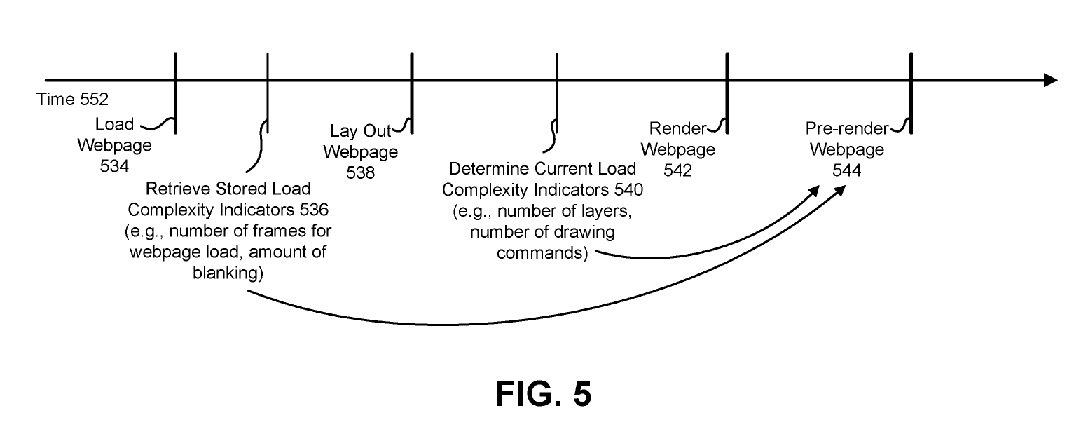

FIG. 5 is a diagram illustrating a timeline of a webpage request and webpage load. In particular, FIG. 5 illustrates several events and/or procedures that may occur over time 552 in accordance with some configurations of the systems and methods disclosed herein. One or more of the procedures described in connection with FIG. 5 may be performed by the electronic device 102 described in connection with FIG. 1 and/or may be performed in accordance with one or more of the functions and/or procedures described in connection with one or more of FIGS. 1-4.

The electronic device 102 may send a webpage request to one or more remote devices. The electronic device 102 may begin receiving the webpage. For example, the electronic device 102 may start receiving webpage data from one or more remote devices.

The electronic device 102 may load 534 the webpage (e.g., begin loading the webpage). In some configurations, webpage loading may begin based on an input and/or event. For example, the electronic device 102 may begin loading 534 a webpage upon receiving keyboard input (e.g., receiving a user-typed uniform resource locator (URL), receiving an enter command, etc.), receiving a mouse input (e.g., a user clicking a link), receiving a speech input (e.g., an audio command to navigate to a page), receiving a touch input, receiving a stylus input, etc. An initial webpage load may be complete (e.g., may end) when at least a visible portion (e.g., viewport) of the webpage is loaded and displayed or when the whole webpage is loaded and displayed. It should be noted that even after the initial webpage load, additional webpage loading may occur. For example, script (e.g., JavaScript) and/or user interaction on the page may cause additional loading (e.g., loading more data as the user has scrolled to the bottom of the page, loading more data when a cursor hovers above an element, etc.). It should be noted that as used herein, a webpage load may refer to an initial webpage load and/or to some or all webpage loading while the webpage is open (e.g., until the webpage is closed, until navigation proceeds to a different webpage, etc.). For example, a number of frames may be counted only for an initial webpage load, for webpage loading within a period of time, or for all webpage loading when the webpage is open, depending on the configuration. Other complexity indicators described herein may be evaluated based on the initial webpage load and/or based on all webpage loading while the webpage is open.

In some configurations, loading 534 the webpage may include one or more of the following. The electronic device 102 may get (e.g., request and/or receive) webpage data (e.g., hypertext markup language (HTML)) from a remote device (e.g., server). The electronic device 102 may load any additional pages, images, and/or scripts referenced (e.g., directly or indirectly referenced) in the page. The electronic device 102 may execute script (e.g., JavaScript), which may cause additional loading. The electronic device 102 may render the currently loaded content while waiting for data (if time permits, for example). The electronic device 102 may render the final content when everything is (e.g., all webpage elements are) loaded (and when there are no more loading activities triggered by script (e.g., JavaScript), for example). In some cases and/or configurations, the electronic device 102 may load previous data (e.g., cached data) for the webpage.

The electronic device 102 may retrieve 536 one or more stored load complexity indicators. For example, the electronic device 102 may retrieve one or more complexity indicators stored in memory from one or more previous webpage loads. Examples of stored load complexity indicators may include a number of layers, a number of frames for webpage load, a size of picture recording (e.g., a number of drawing commands), and/or a pre-rendering performance (e.g., amount of blanking).

The electronic device 102 may lay out 538 the webpage. For example, the electronic device 102 may determine one or more locations of one or more elements and/or sizes of one or more elements on the webpage. In some configurations, laying out 538 the webpage may include parsing the webpage data (e.g., html file) and determining the positions of each element on the webpage (e.g., html page) based on the order and/or hierarchy of how the elements are listed on the webpage. For example, if there are 2 elements listed in the webpage data (e.g., html), the default layout may position them from left to right, or move the second element to the next line if there is no remaining space horizontally (like line wrap for typing in a word processor, for instance). Webpage elements may be defined in a hierarchy such that child elements typically stay within the bound of their parent elements. In one example of a text paragraph, the layout may determine how many lines the paragraph will have based on text size and the amount of horizontal space.

The electronic device 102 may determine 540 one or more current load complexity indicators. Current load complexity indicator(s) may be one or more complexity indicators that may be determined from loading the current webpage. A number of layers and a size of picture recording (e.g., number of drawing commands) are examples of complexity indicators that may be optionally determined from a current webpage load.

The electronic device 102 may render 542 the webpage (e.g., a first area of the webpage). For example, the electronic device 102 may render webpage content within a viewport of a webpage browser (e.g., an on-screen portion, a viewable area, etc.). In some cases, idle time may occur between rendering 542 the webpage and pre-rendering 544 the webpage. For example, the electronic device 102 may detect idle time and may proceed to pre-render 544 the webpage in response to detecting idle time. Alternatively, the electronic device 102 may proceed to pre-render 544 after a threshold amount of idle time has occurred.

The electronic device 102 may pre-render 544 a second area (e.g., all or part of an off-screen portion of the webpage). For example, the electronic device 102 may pre-render 544 the webpage according to an estimated amount of pre-rendering. The estimated amount of pre-rendering may be determined based on one or more retrieved 536 stored load complexity indicators and/or one or more determined 540 current load complexity indicators.

In some configurations, a default amount of pre-rendering may be performed for an initial webpage load. In other configurations, the pre-rendering 544 may be performed according to an amount of pre-rendering estimated based on one or more determined 540 current load complexity indicators for an initial webpage load. For example, one or more stored load complexity indicators may not be available for an initial webpage load. For one or more subsequent webpage loads, the pre-rendering 544 may be performed based on the retrieved 536 stored load complexity indicator(s) and/or the determined 540 current load complexity indicator(s).

It should be noted that one or more complexity indicators associated with the current webpage load may be determined. For example, a number of frames for webpage load may be determined when webpage loading 534 is complete. In some approaches, one or more complexity indicators may be determined after pre-rendering 544. For example, a pre-rendering performance (e.g., amount of blanking) may be determined after pre-rendering 544. Additionally or alternatively, a changing content indicator may be determined in association with the current webpage load 534 (e.g., after webpage loading 534 is complete and/or after pre-rendering 544). One or more complexity indicators may be stored and/or utilized to update stored load complexity indicators (e.g., a webpage complexity profile).

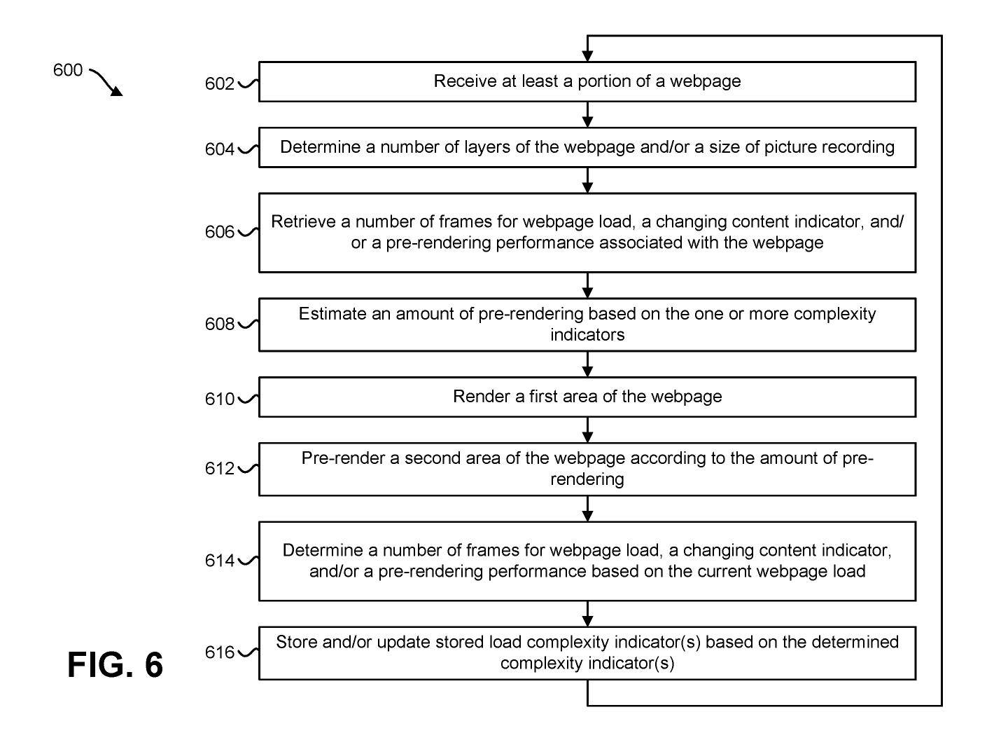

FIG. 6 is a flow diagram illustrating another more specific configuration of a method 600 for controlling webpage pre-rendering. The method 600 may be performed by one or more of the electronic devices described herein (e.g., the electronic device 102 described in connection with FIG. 1). The electronic device 102 may receive 602 at least a portion of a webpage. This may be accomplished as described in connection with one or more of FIGS. 1-5.

The electronic device 102 may optionally determine 604 a number of layers of the webpage and/or a size of picture recording (e.g., number of drawing commands). This may be accomplished as described in connection with one or more of FIGS. 1-2 and 4-5. For example, the electronic device 102 may utilize received webpage data to determine the number of layers and/or size of picture recording.

The electronic device 102 may retrieve 606 a number of frames for webpage load, a changing content indicator, and/or a pre-rendering performance associated with the webpage (if any). This may be accomplished as described in connection with one or more of FIGS. 1-2 and 4-5. For example, the electronic device 102 may retrieve one or more complexity indicators stored in memory (e.g., one or more stored load complexity indicators) determined based on one or more previous webpage loads (if any). In some configurations, the electronic device 102 may retrieve a number of layers of the webpage and/or a size of picture recording (from a previous webpage load, for example). In some approaches, the number of layers of the webpage and/or the size of picture recording from a previous webpage load may be updated with the determined 604 number of layers and/or the size of picture recording for the current webpage load.

The electronic device 102 may estimate 608 an amount of pre-rendering based on the one or more complexity indicators. This may be accomplished as described in connection with one or more of FIGS. 1-5.

The electronic device 102 may render 610 a first area of the webpage. This may be accomplished as described in connection with one or more of FIGS. 1 and 3-5.

The electronic device 102 may pre-render 612 a second area of the webpage (e.g., an off-screen portion of the webpage) according to the amount of pre-rendering. This may be accomplished as described in connection with one or more of FIGS. 1-5.

The electronic device 102 may determine 614 a number of frames for webpage load, a changing content indicator, and/or a pre-rendering performance based on the current webpage load. This may be accomplished as described in connection with one or more of FIGS. 1-2 and 4-5.

The electronic device 102 may store and/or update 616 the one or more stored load complexity indicators based on the determined 604, 614 complexity indicators. This may be accomplished as described in connection with one or more of FIGS. 1 and 4-5.

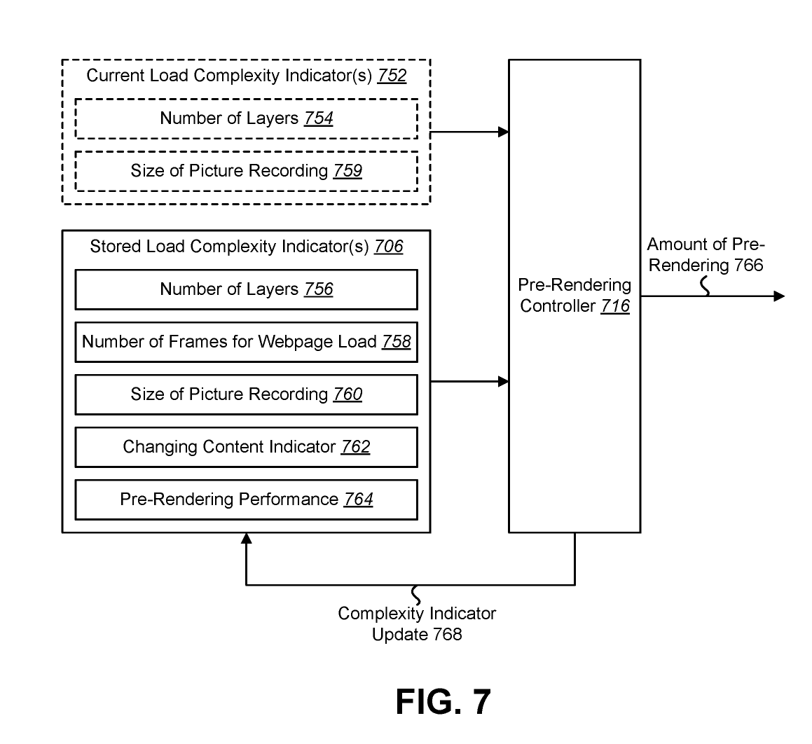

FIG. 7 is a block diagram illustrating an example of stored load complexity indicator(s) 706 and a pre-rendering controller 716. For an initial webpage load (e.g., the first time a particular webpage has been loaded), the pre-rendering controller 716 may optionally obtain (e.g., determine) one or more current load complexity indicators 752. In this example, the pre-rendering controller 716 may optionally obtain a number of layers 754 and/or a size of picture recording 759. The pre-rendering controller 716 may optionally utilize the number of layers 754 and/or the size of picture recording 759 to determine an amount of pre-rendering 766 for the initial webpage load. In other configurations, the pre-rendering controller 716 may utilize a default amount of pre-rendering 766 for an initial webpage load.

For the initial webpage load (e.g., upon requesting a webpage, during a webpage load and/or after completing the webpage load), the pre-rendering controller 716 may determine one or more complexity indicators. For example, the pre-rendering controller 716 may determine a number of layers, a number of frames for webpage load, a size of picture recording, a changing content indicator, and/or a pre-rendering performance. The pre-rendering controller 716 may store a complexity indicator update 768 as one or more stored load complexity indicators 706. For example, the pre-rendering controller 716 may store a number of layers 756, a number of frames for webpage load 758, a size of picture recording 760, a changing content indicator 762, and/or a pre-rendering performance 764.

For a subsequent request and/or loading of the (same) webpage, the pre-rendering controller 716 may utilize an optional number of layers 754 determined as a current load complexity indicator 752, an optional size of picture recording 759, and/or one or more of a number of layers 756, number of frames for webpage load 758, size of picture recording 760, changing content indicator 762, and/or pre-rendering performance 764, which may be retrieved from memory as one or more stored load complexity indicators 706. Based on one or more of these complexity indicators, the pre-rendering controller 716 may determine an amount of pre-rendering 766. The pre-rendering controller 716 may store and/or update one or more complexity indicators as a complexity indicator update 768. For example, the stored load complexity indicator(s) 706 may be overwritten or averaged with the values from the current webpage load.

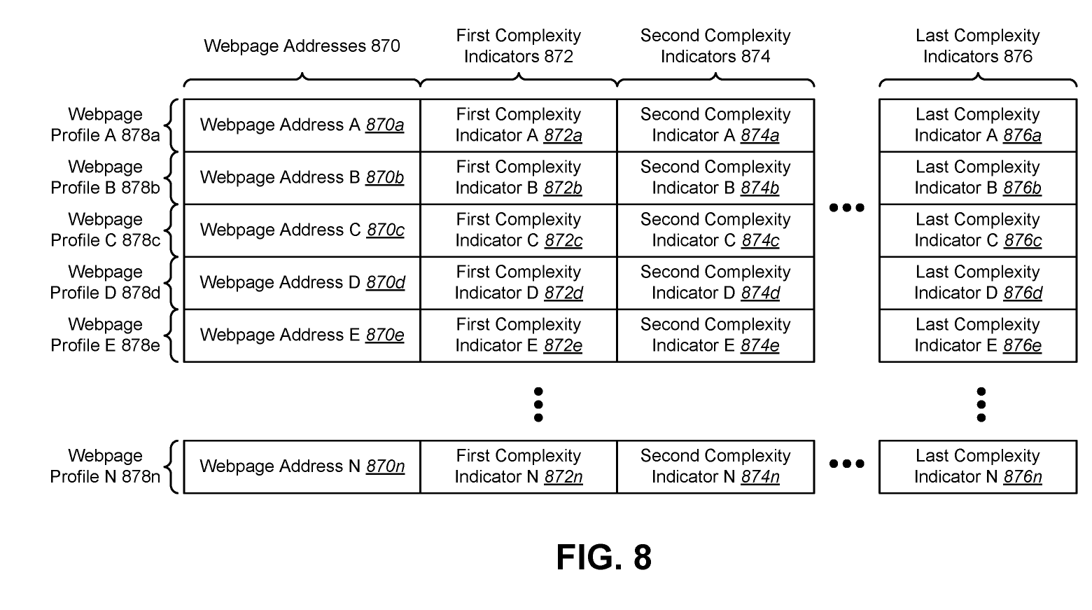

FIG. 8 is a diagram illustrating an example of webpage addresses 870 and complexity indicators 872, 874, 876 that may be stored in accordance with the systems and methods disclosed herein. The webpage addresses 870 described in connection with FIG. 8 may be examples of the webpage addresses 104 described in connection with FIG. 1. The complexity indicators 872, 874, 876 described in connection with FIG. 8 may be examples of the stored load complexity indicators 106 described in connection with FIG. 1.

Webpage addresses 870 may be associated with one or more complexity indicators 872, 874, 876. For example, FIG. 8 illustrates webpage address A 870a associated with first complexity indicator A 872a and second complexity indicator A 874a through last complexity indicator A 876a. Accordingly, webpage addresses A-N 870a-n may be respectively associated with first complexity indicators A-N 872a-n and second complexity indicators A-N 874a-n through last complexity indicators A-N 876a-n. The complexity indicators 872, 874, 876 associated with the webpage addresses 870 may be determined and/or stored from one or more previous webpage requests and/or loads.

In some configurations, a webpage address with one or more associated complexity indicators may be referred to as a webpage profile. As illustrated in FIG. 8, webpage profile A 878a may include webpage address A 870a and first complexity indicator A 872a through last complexity indicator A 876a. Similarly, webpage profile B 878b may include webpage address B 870b and first complexity indicator B 872b through last complexity indicator B 876b, webpage profile C 878c may include webpage address C 870c and first complexity indicator C 872c through last complexity indicator C 876c, webpage profile D 878d may include webpage address D 870d and first complexity indicator D 872d through last complexity indicator D 876d, webpage profile E 878e may include webpage address E 870e and first complexity indicator E 872e through last complexity indicator E 876e, and webpage profile N 878n may include webpage address N 870n and first complexity indicator N 872n through last complexity indicator N 876n. Accordingly, in some configurations, the webpage addresses 104 and stored load complexity indicators 106 described in connection with FIG. 1 may be stored in memory 118 as one or more webpage profiles. As illustrated in FIG. 8, webpage addresses 870 and complexity indicators 872, 874, 876 (e.g., stored load complexity indicators) may be stored in a table structure. Other data structures (e.g., arrays, lists, trees, etc.) may be utilized to store webpage addresses and complexity indicators.

FIG. 9 is a diagram illustrating one example of layers 984 of a webpage 900. In this example, the webpage 900 includes two layers 984. For example, a first layer may include a panel 986 that overlaps (e.g., covers) a second layer with text 988 and an image 990. For example, the panel 986 may include one or more menu items that may be maintained regardless of scrolling the text 988 and image 990 on another layer.

The number of layers illustrated in FIG. 9 (i.e., 2) may be an example of the number of layers L in Equation (1). More layers may contribute to higher (e.g., increased) amounts of pre-rendering.

As illustrated in FIG. 9, a viewport 980 portion of the webpage 900 may be rendered (e.g., presented). The pre-render area 982 may be initially outside of the viewport 980.

FIG. 10 is a diagram illustrating one example of complex content 1092 of a webpage 1000. In this example, the webpage 1000 includes complex content 1092. Complex content may lead to a large size of picture recording. For example, many drawing commands and/or long drawing commands may be utilized to draw many different elements (e.g., text, images, panels, controls, etc.).

The number of drawing commands and/or long drawing commands for the complex content in FIG. 10 may be an example of the number of drawing commands D in Equation (1). Complex content (e.g., more drawing commands and/or longer drawing commands) may contribute to higher (e.g., increased) amounts of pre-rendering.

FIG. 11 is a diagram illustrating one example of frames 1194a-c for a webpage load. In this example, three frames (frames A-C 1194a-c) are utilized to load a webpage over time 1111. In this example, title A 1196a, paragraph A 1198a, and blank image A 1101a are loaded in frame A 1194a. In the next frame, frame B 1194b, title B 1196b, paragraph B 1198b, and blank image B 1101b are already loaded (e.g., they are the same as title A 1196a, paragraph A 1198a, and blank image A 1101a, respectively, from frame A 1194a). In frame B 1194b, more loaded content 1109 includes second blank image B 1105b (and other content, such as text, for example). In the next frame, frame C 1194c, title C 1196c, paragraph C 1198c, and other content are already loaded. In frame C 1194c, image C 1103c and second image C 1107c are loaded and the webpage load is finished 1113.

The number of frames in FIG. 11 is three, which may be an example of the number of frames F in Equation (1). More frames may contribute to higher (e.g., increased) amounts of pre-rendering.

FIG. 12 is a diagram illustrating one example of pre-rendering performance (e.g., blanking 1221) of a webpage 1215, 1217. In this example, a previous load of the webpage 1215 has viewport A 1219a, which was moving downward on the content. In this case, blanking 1221 occurred on two tiles, where the tiles were not ready (e.g., not rendered) in time to avoid blanking as viewport A 1219a moved downward.

The amount of blanking 1221 illustrated in FIG. 12 (i.e., 2 tiles) may be an example of the blanking B in Equation (1). More blanking during scrolling (e.g., a larger blanking area, a larger number of blank tiles, lower pre-rendering performance, etc.) may contribute to higher (e.g., increased) amounts of pre-rendering.

As illustrated in FIG. 12, a pre-render area 1223 may be pre-rendered for a current load of the webpage 1217. For example, the webpage content corresponding to viewport B 1219b may be rendered and the webpage content in the pre-render area 1223 may be pre-rendered to avoid blanking in the current load of the webpage 1217.

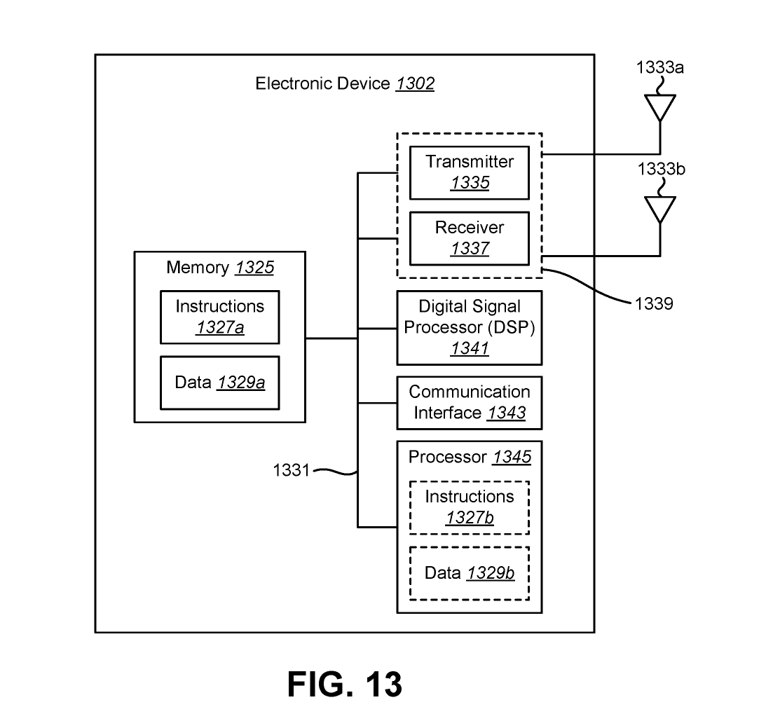

FIG. 13 illustrates certain components that may be included within an electronic device 1302 configured to implement various configurations of the systems and methods disclosed herein. Examples of the electronic device 1302 may include cellular phones, smart phones, computers (e.g., desktop computers, laptop computers, etc.), tablet devices, media players, televisions, vehicles, automobiles, cameras, virtual reality devices (e.g., headsets), augmented reality devices (e.g., headsets), mixed reality devices (e.g., headsets), aircraft, healthcare equipment, gaming consoles, personal digital assistants (PDAs), set-top boxes, appliances, etc. The electronic device 1302 may be implemented in accordance with the electronic device 102 described in connection with FIG. 1.

The electronic device 1302 includes a processor 1345. The processor 1345 may be a general purpose single- or multi-chip microprocessor (e.g., an advanced reduced instruction set computing (RISC) machine (ARM)), a special purpose microprocessor (e.g., a digital signal processor (DSP), a graphics processing unit (GPU)), a microcontroller, a programmable gate array, etc. The processor 1345 may be referred to as a central processing unit (CPU). Although just a single processor 1345 is shown in the electronic device 1302, in an alternative configuration, a combination of processors (e.g., an ARM and DSP, an application processor and a GPU, etc.) could be implemented.

The electronic device 1302 also includes memory 1325. The memory 1325 may be any electronic component capable of storing electronic information. The memory 1325 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

Data 1329a and instructions 1327a may be stored in the memory 1325. The instructions 1327a may be executable by the processor 1345 to implement one or more of the methods 200, 400, 600, procedures, steps, and/or functions described herein. Executing the instructions 1327a may involve the use of the data 1329a that is stored in the memory 1325. When the processor 1345 executes the instructions 1327, various portions of the instructions 1327b may be loaded onto the processor 1345 and/or various pieces of data 1329b may be loaded onto the processor 1345.

The electronic device 1302 may also include a transmitter 1335 and a receiver 1337 to allow transmission and reception of signals to and from the electronic device 1302. The transmitter 1335 and receiver 1337 may be collectively referred to as a transceiver 1339. One or more antennas 1333a-b may be electrically coupled to the transceiver 1339. The electronic device 1302 may also include (not shown) multiple transmitters, multiple receivers, multiple transceivers and/or additional antennas.

The electronic device 1302 may include a digital signal processor (DSP) 1341. The electronic device 1302 may also include a communication interface 1343. The communication interface 1343 may allow and/or enable one or more kinds of input and/or output. For example, the communication interface 1343 may include one or more ports and/or communication devices for linking other devices to the electronic device 1302. In some configurations, the communication interface 1343 may include the transmitter 1335, the receiver 1337, or both (e.g., the transceiver 1339). Additionally or alternatively, the communication interface 1343 may include one or more other interfaces (e.g., touchscreen, keypad, keyboard, microphone, camera, etc.). For example, the communication interface 1343 may enable a user to interact with the electronic device 1302.

The various components of the electronic device 1302 may be coupled together by one or more buses, which may include a power bus, a control signal bus, a status signal bus, a data bus, etc. For the sake of clarity, the various buses are illustrated in FIG. 13 as a bus system 1331.

The term “determining” encompasses a wide variety of actions and, therefore, “determining” can include calculating, computing, processing, deriving, investigating, looking up (e.g., looking up in a table, a database or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed, or computed by the computing device or processor. As used herein, the term “code” may refer to software, instructions, code, or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes, and variations may be made in the arrangement, operation, and details of the systems, methods, and apparatus described herein without departing from the scope of the claims.

1. A method for controlling webpage pre-rendering, comprising:
receiving at least a portion of a webpage;
obtaining one or more complexity indicators associated with the webpage, wherein the one or more complexity indicators include at least a size of picture recording;
estimating an amount of pre-rendering based on the one or more complexity indicators; and
pre-rendering an off-screen portion of the webpage according to the amount of pre-rendering.

2. The method of claim 1, further comprising storing one or more load complexity indicators based on one or more webpage loads.

3. The method of claim 1, wherein the one or more complexity indicators further include one or more of: a number of layers, a number of frames for webpage load, a changing content indicator, or a pre-rendering performance.

4. The method of claim 3, wherein at least one of an increased number of layers, an increased number of frames, an increased size of picture recording, a decreased changing content indicator, or a decreased pre-rendering performance contributes to increasing the amount of pre-rendering.

5. The method of claim 3, wherein at least one of a decreased number of layers, a decreased number of frames, a decreased size of picture recording, an increased changing content indicator, or an increased pre-rendering performance contributes to decreasing the amount of pre-rendering.

6. The method of claim 1, wherein obtaining the one or more complexity indicators comprises:
determining one or more current load complexity indicators; and
retrieving one or more stored load complexity indicators.

7. An electronic device for controlling webpage pre-rendering, comprising:
a processor configured to:
receive at least a portion of a webpage;
obtain one or more complexity indicators associated with the webpage, wherein the one or more complexity indicators include at least a size of picture recording;
estimate an amount of pre-rendering based on the one or more complexity indicators; and
pre-render an off-screen portion of the webpage according to the amount of pre-rendering.

8. The electronic device of claim 7, wherein the processor is configured to store one or more load complexity indicators based on one or more webpage loads.

9. The electronic device of claim 7, wherein the one or more complexity indicators further include one or more of: a number of layers, a number of frames for webpage load, a changing content indicator, or a pre-rendering performance.

10. The electronic device of claim 9, wherein at least one of an increased number of layers, an increased number of frames, an increased size of picture recording, a decreased changing content indicator, or a decreased pre-rendering performance contributes to increasing the amount of pre-rendering.

11. The electronic device of claim 9, wherein at least one of a decreased number of layers, a decreased number of frames, a decreased size of picture recording, an increased changing content indicator, or an increased pre-rendering performance contributes to decreasing the amount of pre-rendering.

12. The electronic device of claim 7, wherein the processor is configured to obtain the one or more complexity indicators by determining one or more current load complexity indicators and retrieving one or more stored load complexity indicators.

13. A computer-program product for controlling webpage pre-rendering, comprising a non-transitory tangible computer-readable medium having instructions thereon, the instructions comprising:
code for causing an electronic device to receive at least a portion of a webpage;
code for causing the electronic device to obtain one or more complexity indicators associated with the webpage, wherein the one or more complexity indicators include at least a size of picture recording;
code for causing the electronic device to estimate an amount of pre-rendering based on the one or more complexity indicators; and
code for causing the electronic device to pre-render an off-screen portion of the webpage according to the amount of pre-rendering.

14. The computer-program product of claim 13, the instructions further comprising code for causing the electronic device to store one or more load complexity indicators based on one or more webpage loads.

15. The computer-program product of claim 13, wherein the one or more complexity indicators further include one or more of: a number of layers, a number of frames for webpage load, a changing content indicator, or a pre-rendering performance.

16. The computer-program product of claim 15, wherein at least one of an increased number of layers, an increased number of frames, an increased size of picture recording, a decreased changing content indicator, or a decreased pre-rendering performance contributes to increasing the amount of pre-rendering.

17. The computer-program product of claim 15, wherein at least one of a decreased number of layers, a decreased number of frames, a decreased size of picture recording, an increased changing content indicator, or an increased pre-rendering performance contributes to decreasing the amount of pre-rendering.

18. The computer-program product of claim 13, wherein the code for causing the electronic device to obtain the one or more complexity indicators comprises:
code for causing the electronic device to determine one or more current load complexity indicators; and
code for causing the electronic device to retrieve one or more stored load complexity indicators.

19. An apparatus for controlling webpage pre-rendering, comprising:
means for receiving at least a portion of a webpage;
means for obtaining one or more complexity indicators associated with the webpage wherein the one or more complexity indicators include at least a size of picture recording;
means for estimating an amount of pre-rendering based on the one or more complexity indicators; and
means for pre-rendering an off-screen portion of the webpage according to the amount of pre-rendering.

20. The apparatus of claim 19, further comprising means for storing one or more load complexity indicators based on one or more webpage loads.

21. The apparatus of claim 19, wherein the one or more complexity indicators further include one or more of: a number of layers, a number of frames for webpage load, a changing content indicator, or a pre-rendering performance.

22. The apparatus of claim 21, wherein at least one of an increased number of layers, an increased number of frames, an increased size of picture recording, a decreased changing content indicator, or a decreased pre-rendering performance contributes to increasing the amount of pre-rendering.

23. The apparatus of claim 21, wherein at least one of a decreased number of layers, a decreased number of frames, a decreased size of picture recording, an increased changing content indicator, or an increased pre-rendering performance contributes to decreasing the amount of pre-rendering.

24. The apparatus of claim 19, wherein the means for obtaining the one or more complexity indicators comprises:
means for determining one or more current load complexity indicators; and
means for retrieving one or more stored load complexity indicators.
